(19) United States
(12) Patent Application Publication
(10) Pub. No.: US 2005/0028381 A1
(43) Pub. Date: Feb. 10, 2005

(54) Run-through shears

(75) Inventor: Siegfried Foshag, Neuhausen (DE)

Correspondence Address: LAW OFFICE OF BARRY R LIPSITZ, 755 MAIN STREET, MONROE, CT, 06468, US

(73) Assignee: Bessey & Sohn GmbH & Co. KG, Bietigheim-Bissingen (DE)

(21) Appl. No.: 10/788,968

(22) Filed: Feb. 25, 2004

(30) Foreign Application Priority Data
Mar. 5, 2003 (DE) 103 10 259.0

(51) Int. Cl. B26B 13/00

(52) U.S. Cl. 30/233

(57) ABSTRACT

In order for run-through shears in the case of which the user's hand is located at a distance from the workpiece during cutting, comprising a shears head which is formed by a first shears-head limb with a first cutting blade and by a second shears-head limb with a second cutting blade, also comprising a first handle part and a second handle part, a first handle-part/shears-head-limb combination and a second handle-part/shears-head-limb combination being formed and at least one handle part being disposed in an angled manner relative to the shears head, and further comprising a rotary bearing for pivoting the handle-part/shears-head-limb combinations relative to one another, to be improved such that they can be produced cost-effectively and have a low weight, it is provided that the cutting blades are individual parts which are fixed on cutting-blade retaining regions of the associated shears-head limbs, and that the parts forming the cutting blades are spaced away from the rotary bearing.

The present disclosure relates to the subject matter disclosed in German application No. 103 10 259.0 of Mar. 5, 2003, which is incorporated herein by reference in its entirety and for all purposes.

### BACKGROUND OF THE INVENTION

The invention relates to run-through shears in the case of which the user's hand is located at a distance from the workpiece during cutting, comprising a shears head which is formed by a first shears-head limb with a first cutting blade and by a second shears-head limb with a second cutting blade, also comprising a first handle part and a second handle part, a first handle-part/shears-head-limb combination and a second handle-part/shears-head-limb combination being formed and at least one handle part being disposed in an angled manner relative to the shears head, and further comprising a rotary bearing for pivoting the handle-part/shears-head-limb combinations relative to one another.

Such run-through shears are known, for example, by the name “Ideal-Schere” from Bessey & Sohn GmbH & Co.

Run-through shears can be used to make a long continuous cut in a workpiece. The angled arrangement of the handle part or parts relative to the shears head then ensures that the user's hand guides the run-through shears over the workpiece. The user's hand thus does not come into contact with the cut material and thus, in addition, does not prevent the latter from being transported further. Furthermore, injuries from sharp-edged cut material are thus also avoided.

Such run-through shears can be used to cut sheet-like materials such as paper, paperboard or metal sheets.

### SUMMARY OF THE INVENTION

In accordance with the present invention, improved run-through shears (tinsnips) are provided that can be produced cost-effectively and have a low weight.

This is achieved in that the cutting blades are individual parts which are fixed on cutting-blade retaining regions of the associated shears-head limbs, and in that the parts forming the cutting blades are spaced away from the rotary bearing.

By virtue of the solution according to the invention, in the case of which the cutting blades are separately produced parts which are not involved in the formation of the rotary bearing, it is possible to separate the cutting function from the mechanical function in respect of mounting the handle-part/shears-head-limb combinations on one another. This allows separate optimization. It is thus possible to produce the cutting blades in particular from thin sheet-metal parts, which are sufficient in principle for the cutting action. The handle-part/shears-head-limb combinations may be produced, for example, from a plastics material in order thus for the weight to be kept low.

There is no need then to provide a forged shears head, i.e. a shears head in the case of which the cutting blades are formed integrally on the shears-head limbs. In the case of a forged shears head, allowance is made for the warping of the shears-head limb, which is present following forging, by virtue of the cutting blade being overdimensioned to a correspondingly great extent. During grinding, the excess is correspondingly removed and the cutting blade is sharpened. However, the production outlay is high and the corresponding run-through shears have a high weight.

Thin sheet-metal parts which form the cutting blade and likewise the joint, i.e. form the sliding surfaces for the rotary bearing, cannot be produced with the tolerance which is necessary for the run-through shears to be capable of functioning, since the bending process has excessively large tolerances. It would therefore be necessary to process thick sheet-metal parts by removing material therefrom, (for example by grinding), in order to provide a run-through shears function. The production process then involves correspondingly high outlay.

The solution according to the invention, i.e. separating the mounting and cutting functions, allows the requirements in respect of the mounting and of the cutting action to be optimized separately, it being possible for run-through shears according to the invention to be produced cost-effectively and to be easily formed.

In particular, it is provided that the sliding surfaces of the rotary bearing (the joint) are located outside the parts forming the cutting blades. This makes it possible to separate the mechanical mounting function and cutting-blade formation.

In particular, a sliding surface of the rotary bearing, said sliding surface being formed on the associated handle-part/shears-head-limb combination, is formed outside the associated cutting-blade retaining region. This means that the cutting blades themselves do not form sliding surfaces for the rotary bearing. Production is thus simplified once again.

In particular, the cutting blades are made of metal. This makes it possible to achieve a good cutting action since sharp cutting edges in particular can be produced. In particular, the cutting blades here are produced from thin sheet metal.

Furthermore, it is advantageous if the handle parts are produced from a plastics material. On account of the rotary mounting function and cutting function being separated according to the invention, the handle part can thus be adapted in optimized fashion, it being possible for the run-through shears to be easily formed.

For the same reason, it is advantageous if the shears-head limbs are produced from a plastics material. The metallic cutting blades are then seated on the shears-head limbs, it being possible for these cutting blades to be optimized separately from the mounting of the handle-part/shears-head-limb combinations.

It is quite particularly advantageous if the first handle-part/shears-head-limb combination is formed in one piece. In particular in the case of being produced from a plastics material, such a combination can then be formed integrally, for example, via injection molding. It is thus possible to reduce the production costs.

For the same reason, it is advantageous if the second handle-part/shears-head-limb combination is formed in one piece.

It is advantageous if the shears head has one or more guiding surfaces for spaced-apart guidance of cut material past the rotary bearing. This makes it possible to avoid the situation where the cut material is bent over in order to be guided past the rotary bearing. In particular relatively inflexible materials (in comparison to paper) such as sheet metal or paperboard can thus be cut and, in particular, it is possible to make a long continuous cut in such a workpiece.

It is advantageous if the first shears-head limb has a guiding surface for cut material and likewise if the second shears-head limb has such a guiding surface.

In particular, the guiding surfaces are spaced apart from the rotary bearing in a height direction transverse to the axis of rotation of the rotary bearing. This ensures that cut material is guided past the rotary bearing without the cut material having to be bent over.

It is further advantageous if a guiding surface extends in a direction along a cutting edge of the associated cutting blade and in a direction which is at least approximately parallel to the axis of rotation of the rotary bearing. A guiding surface thus extends laterally outward on a shears-head limb in a direction away from the associated cutting blade, i.e. the shears head is offset laterally in relation to the cutting blade in order to provide such a guiding surface.

In particular, a cutting blade projects beyond the associated guiding surface, in order for it to be possible to make a cut in the workpiece.

In order to achieve a good cutting action in the case of the run-through shears according to the invention, the rotary bearing is preferably disposed in an extension of the first cutting blade in a direction away from a distal end. This makes it possible to achieve a cutting movement in the case of which the run-through shears are guided above the workpiece and the first handle-part/shears-head-limb combination is pivoted relative to the second handle-part/shears-head-limb combination, the second handle part then being located above the first handle part.

For mounting purposes, the first handle-part/shears-head-limb combination preferably has a recess in which the second handle-part/shears-head-limb combination is disposed in a rotatable manner. On the one hand, this makes it possible to ensure that the handle parts are aligned in respect of their retaining surfaces. On the other hand, it is possible to form laterally projecting guiding surfaces on the limbs of the shears head.

A recess is then bounded toward one side by the cutting-blade retaining region of the first shears-head limb. The recess is bounded toward the other side by the first handle part.

By virtue of the mechanical mounting and cutting functions being separated according to the invention, it is advantageously possible for the recess to provide a blocking surface which limits the extent to which the shears head opens. If the second handle-part/shears-head-limb combination strikes against this blocking surface, then the mouth of the shears head cannot open any further. This blocking surface may be formed integrally on the first handle-part/shears-head-limb combination without any particular additional production outlay being necessary for this purpose.

In particular, here, a depth direction of the recess is parallel to the axis of rotation, in order thus to achieve a flush alignment of the handle parts and in order also for it to be possible to form the guiding surface on the shears-head limbs.

It is advantageous in terms of production technology if a bearing recess with a sliding surface is formed on one handle-part/shears-head-limb combination, and a shaft stub with an associated sliding surface is seated in a rotationally fixed manner on the other handle-part/shears-head-limb combination. Such a bearing recess and such a shaft stub may be formed integrally on the handle-part/shears-head-limb combinations. The corresponding sliding surfaces (the joint) may also be formed integrally, so that, once again, the cutting blades can be formed, and produced, separately therefrom.

Run-through shears according to the invention can be produced in a straightforward manner if the cutting blades are fixed on the associated shears-head limbs via one or more fastening elements. In particular here, the fastening elements are positively locking elements, so that assembly can be carried out straightforwardly and quickly.

In particular here, the cutting blades are fixed in from their surface by, for example, countersinkable screws retaining the cutting blades on the associated shears-head limbs.

It is advantageously provided that, in the case of the second handle-part/shears-head-limb combination, the second handle part, or an element connected to the second handle part, is connected substantially at right angles to the second shears-head limb. When the user's hand guides the run-through shears above the workpiece, the second handle part is located above the first handle part. The spaced-apart positioning of the hand in relation to the workpiece can easily be achieved by the second handle part, or an element connected thereto, being disposed in a correspondingly angled manner on the associated shears-head limb.

It is advantageous if a compression spring is disposed between the two handle-part/shears-head-limb combinations and opens the shears head in the non-loaded state. For closing the shears head, i.e. for executing a cutting movement, the compressive force of this compression spring then has to be overcome. By virtue of this compressive force being reduced, the mouth of the shears head then opens again in order for it to be possible to start a further cut in the workpiece by advancing the shears head.

It is further advantageous if a locking device, by means of which a closed position of the shears head can be fixed, is provided. This closed position is a storage position, in which the cutting edges of the cutting blades are not exposed, so that a user is protected against accidental contact with the cutting edges.

The following description of a preferred embodiment serves, in conjunction with the drawing, for explaining the invention in more detail.

### BRIEF DESCRIPTION OF THE DRAWINGS

FIG. 1 shows a first perspective illustration of an exemplary embodiment of run-through shears according to the invention;

FIG. 2 shows a second perspective view of the run-through shears according to FIG. 1;

FIG. 3 shows a perspective illustration of a first handle-part/shears-head-limb combination; and

FIG. 4 shows a second handle-part/shears-head-limb combination, the two handle-part/shears-head-limb combinations forming the run-through shears according to FIGS. 1 and 2.

### DETAILED DESCRIPTION OF THE INVENTION

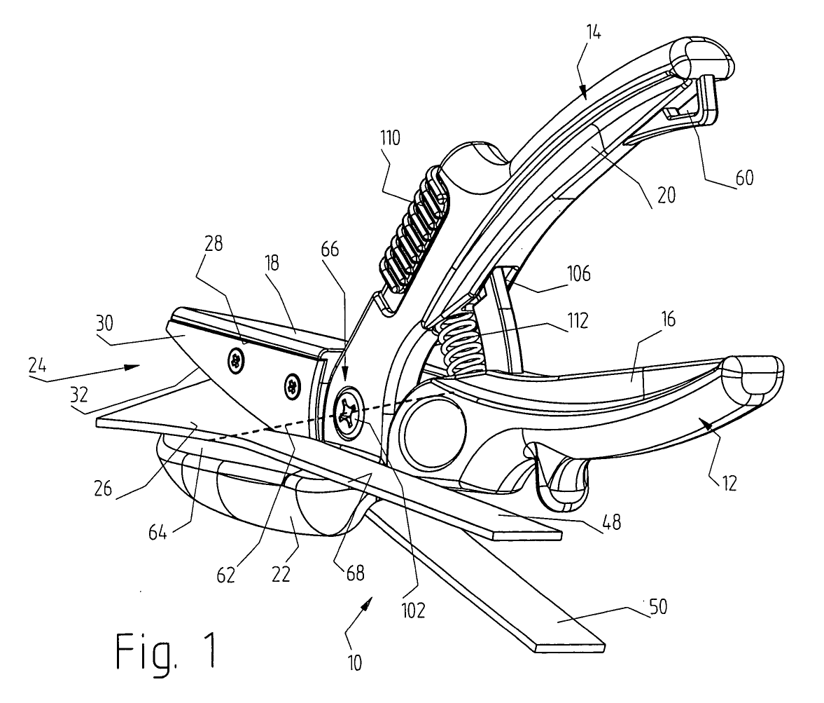

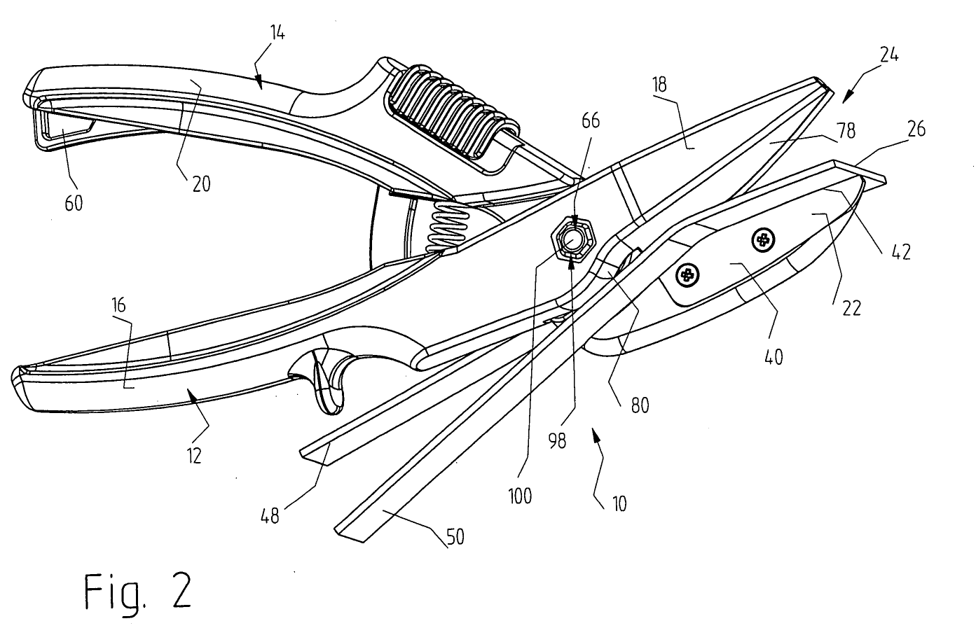

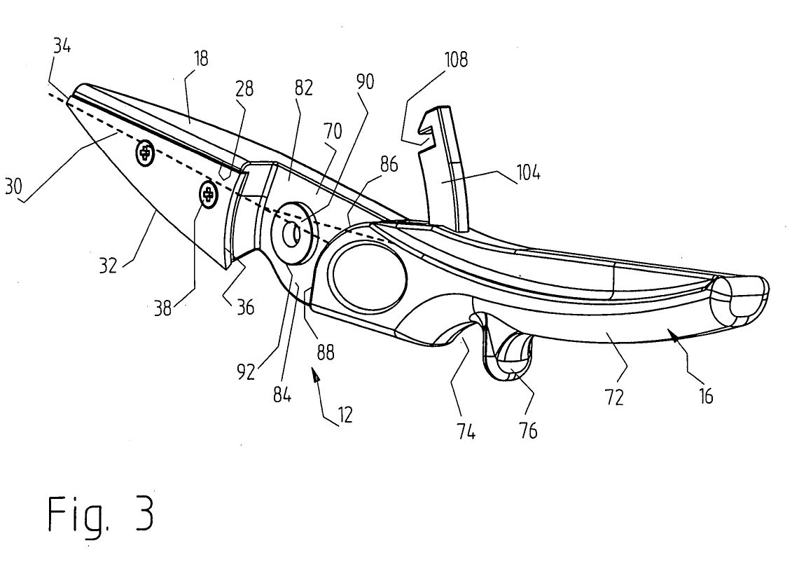

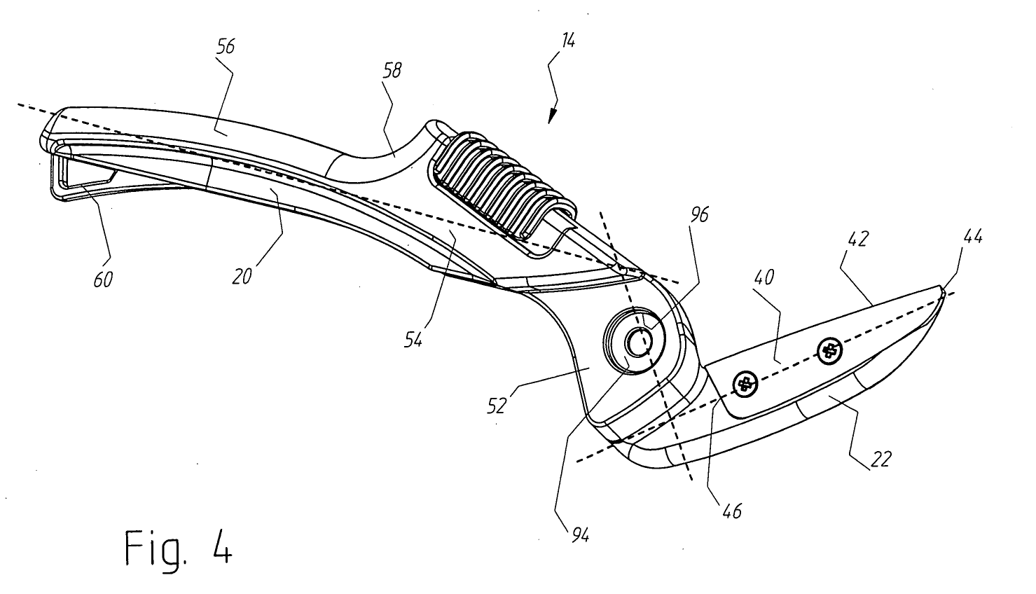

An exemplary embodiment of run-through shears according to the invention, which are designated as a whole by 10 in FIGS. 1 and 2, comprises a first handle-part/shears-head-limb combination 12 (FIG. 3) and a second handle-part/shears-head-limb combination 14 (FIG. 4). The first handle-part/shears-head-limb combination 12, in turn, comprises a first handle part 16 and a first shears-head limb 18. The second handle-part/shears-head-limb combination 14 comprises a second handle part 20 and a second shears-head limb 22.

The two shears-head limbs 18 and 22 form a shears head 24, the extent of whose mouth is adjustable by pivoting of the two handle parts 16 and 20. A cut can be made in a workpiece 26 by virtue of the two handle parts 16 and 20 being moved toward one another.

The first shears-head limb 18 has a cutting-blade retaining region 28, on which a first cutting blade 30 is seated. The first cutting blade 30 here has a cutting edge 32. It is produced from a metallic material and is, in particular, of plate-like configuration and extends between a first boundary plane and a second boundary plane, these two boundary planes being located substantially parallel to one another.

The first cutting blade 30 has a smaller width at a distal end 34 than the opposite end 36. The cutting edge 32 runs between these ends 34 and 36 and is curved.

The first cutting blade 30 is fixed on the associated first shears-head limb 18 by means of positively locking fastening elements 38, in particular screws. The first cutting blade 30 is an individual part, i.e. a part which is separate from the first shears-head limb 18 and is subsequently fixed on the latter by the fastening elements 38.

A second cutting blade 40, which is seated on the second shears-head limb 22 at a corresponding cutting-blade retaining region, is formed in the same way as the first cutting blade 30. A cutting edge 42 runs between a distal end 44 and an opposite end 46. The second cutting blade 40 is likewise fixed on the associated second shears-head limb 22 by fastening elements such as screws; the second cutting blade 40 also forms an individual part which is subsequently fixed.

The two cutting blades 30 and 40 are formed such that they can slide past one another in the region of their cutting edges 32 and 42 in order to be able to make a cut in the workpiece 26.

The two cutting blades 30 and 40 are formed, in particular, as thin sheet-metal parts.

The shears according to the invention are run-through shears. In the case of such run-through shears, the user's hand which grips the handle parts 16 and 20 is located above the workpiece 26 during cutting, so that, on the one hand, the user's hand does not disturb the shears running through the workpiece 26 and, on the other hand, a safe distance from the cut material 48, 50 is ensured; in particular in the case of sheet-metal parts as the workpieces which are to be cut, the cut materials 48, 50 may have sharp cut edges from which there is a risk of injury.

In order to form run-through shears, the second handle part 20 in the second handle-part/shears-head-limb combination 14 is disposed in an angled manner on the second shears-head limb 22. For this purpose, the second handle part 20 comprises a transition region 52 via which the second handle part 20 is connected to the second shears-head limb 22. This transition region 52 is seated on the second shears-head limb 22 and is oriented substantially at right angles to the latter. The transition region 52 is adjoined by a handle region 54, which is seated on the transition region 52 at an acute angle, for example in the order of magnitude of 45°.

The handle region 54 is of slightly curved formation overall and has an ergonomically shaped hand-abutment region 56 on its outside. It is provided with a sliding-prevention means 58, which is formed by an outwardly oriented abutment surface. The hollow between the thumb and forefinger can be positioned in this abutment surface.

The handle region 54 may be provided on its inside, which is directed toward the first handle part 16, with an eyelet 60, via which the run-through shears 10 can be hung up for sales display or for storage purposes.

The second handle-part/shears-head-limb combination 14 is of step-like formation in a front view, i.e. the transition between the second shears-head limb 22 and the transition region 52 of the second handle part 20 and the transition between the transition region 52 and the handle region 54 are located on different planes. Furthermore, a boundary plane of the transition region 52 which is located transversely to an axis of rotation 62 of the two handle-part/shears-head-limb combinations when the latter are pivoted relative to one another, is spaced apart from a corresponding boundary plane of the handle region 54.

It is thus the case, on the one hand, that the transition region 52 is set back in relation to the abovementioned boundary plane of the handle region 54. In addition, the second shears-head limb 22 extends beyond the other boundary plane of the transition region 52, in a direction away from the cutting edge 42.

The second shears-head limb 22 is thus offset laterally in relation to the second cutting blade 40, this resulting in the formation of a guiding surface 64 (FIG. 1) which extends at least approximately in the direction of the cutting edge 42 and at least approximately parallel to the axis of rotation 62. This guiding surface 64 is located beneath a rotary bearing 66, by means of which the two handle-part/shears-head-limb combinations 12 and 14 can be pivoted relative to one another.

The guiding surface 64 extends from an end of the second shears-head limb 22 which is located in the region of the distal end 44 of the second cutting blade 40 into the transition region 52, at which the second shears-head limb 22 is joined to the second handle part 20. In particular, a region 68 of the guiding surface 64 is also located directly beneath the rotary bearing 66.

The cutting edge 42 has to be at least flush with the guiding surface 64. In the exemplary embodiment shown, the second cutting blade 40 has its cutting edge 42 projecting beyond this guiding surface 64.

By virtue of the guiding surface 64, it is possible for cut material 48, following cutting of the workpiece 26, to be guided past the rotary bearing 66 and in particular beneath the latter. This prevents cut material 48 from having to be bent over. In particular, it is thus possible for relatively inflexible materials such as sheet metal or paperboard to be guided past the rotary bearing 66, so that a long continuous cut can be made in the workpiece 26.

The second shears-head limb 22 and the second handle part are preferably produced from a plastics material, in order for the weight of the run-through shears 10 according to the invention to be kept low. In particular here, they are joined integrally to one another. The second handle-part/shears-head-limb combination 14 may thus be produced integrally, for example, by means of injection molding.

The first handle-part/shears-head-limb combination 12 likewise has a transition region 70, which connects the first shears-head limb 18 to a handle region 72 of the first handle part 16.

The handle region 72 here is of ergonomic configuration on its outside. It has a positioning cavity 74 for the user's forefinger. This positioning cavity 74 is bounded, in the direction of a proximal end of the first handle part 16, by a protuberance 76, the opposite surface of which, in turn, forms an abutment surface for the user's middle finger.

The first handle part 16 is of slightly curved formation. The first handle part 16 is seated on the first shears-head limb 18, in the transition region 70, at a small acute angle, for example in the order of magnitude of 25°.

The first shears-head limb 18 also has a guiding surface 78 (FIG. 2), via which the cut material 50 can be guided past the rotary bearing 66. The guiding surface 78 here extends in a direction along the cutting edge 32 of the first cutting blade 30 and at least approximately parallel to the axis of rotation 62. Beneath the rotary bearing, this guiding surface 78 may have a region 80 which is curved such that the cut material 50 is indeed guided past beneath the rotary bearing 66 along this guiding surface 78.

The cutting edge 32 has to be at least flush with the guiding surface 78. In the exemplary embodiment shown, the first cutting blade 30 has its cutting edge 32 projecting beyond this guiding surface 78.

The first handle part 16 and the first shears-head limb 18 are preferably produced from a plastics material, in order to achieve a low weight for the run-through shears 10. In particular, the first handle-part/shears-head-limb combination 12 is formed in one piece, it then being possible for this combination to be produced integrally, for example, via injection molding.

The rotary bearing 66 is disposed in the transition region 70 of the first handle-part/shears-head-limb combination 12 and the transition region 52 of the second handle-part/shears-head-limb combination 14. The transition region 70 has a recess 82, which is bounded toward the first shears-head limb 18 by the cutting-blade retaining region 28. A depth direction of this recess 82 is essentially parallel to the axis of rotation 62.

The recess 82 is bounded toward the other side by a wall 86 of the handle region 72, this wall projecting substantially at right angles from a recess base 84. At least in a lower region 88, which is directed away from the second handle part 20, this abutment surface forms a blocking surface which limits the extent of the mouth of the shears head 26, i.e. limits the pivoting angle of the two handle-part/shears-head-limb combinations 12 and 14 in the upward direction.

The second handle-part/shears-head-limb combination 14 is mounted, by way of its transition region 52, in the recess 82 of the first handle-part/shears-head-limb combination 12 such that it can be pivoted via the rotary bearing 66. The recess 82 and the transition region 52 form the joint of the run-through shears according to the invention.

In order to form the rotary bearing 66, for this purpose, a shaft stub 90 is formed, for example, in the transition region 70, this stub projecting from the recess base 84 and having a cylindrical sliding surface 92. This shaft stub 90 is seated in a rotationally fixed manner on the first handle-part/shears-head-limb combination 12.

The second handle-part/shears-head-limb combination 14 has, in its transition region 52, a cylindrical recess 94 which corresponds with the shaft stub and has a hollow-cylindrical sliding surface 96. When the two handle-part/shears-head-limb combinations 12 and 14 rotate in the rotary bearing 66, the sliding surfaces 92 and 96 slide on one another. The axial displacement of the two handle-part/shears-head-limb combinations 12 and 14 parallel to the axis of rotation 62 is blocked by a securing device 98 (FIG. 2), so that it is only the pivoting movement about the axis of rotation 62 in the rotary bearing 66, i.e. the rotational sliding of the sliding surfaces 92 and 96 on one another, which is allowed. For this purpose, the securing device 98 comprises, for example, a pin 100, which is connected in a rotationally fixed manner to the first handle-part/shears-head-limb combination 12, and an abutment element 102, which is seated in a rotationally fixed manner on this pin 100 and blocks the axial movement of the second handle-part/shears-head-limb combination 14, rotation about this abutment element 102 being permitted.

The shaft stub 90 is disposed in the transition region 70, in an extension of the first cutting blade 30 in the direction away from the distal end 34. The first cutting blade 30 is spaced apart from the shaft stub 90 and is thus also spaced apart from the rotary bearing 66.

The recess 94 in the transition region 52 of the second handle-part/shears-head-limb combination 14 is disposed above a rearward extension of the second cutting blade 40, i.e. an extension in a direction away from the distal end 44. The rotary bearing 66 is thus also spaced apart from the second cutting blade 40. In particular, the sliding surfaces 92 and 96 are located outside the cutting-blade retaining regions 28 and thus also outside the cutting blades 30 and 40.

A latching element 104 is seated in the handle region 72 of the first handle-part/shears-head-limb combination 12, projecting beyond an inner surface and is directed towards the second handle part 20. Associated with this latching element 104, the second handle part 20 has a recess 106. The second handle part 20 can be coupled to the latching element 104 via this recess 106.

For this purpose, the latching element 104 has a recess 108 in the region of its upper end, which is directed toward the second handle part 20. Seated on the second handle part 20 is a slide 110 with a blocking element, which can engage in this recess 108. The latching element 104 with the recess 108 then is adapted to the slide 110 with its blocking element such that the blocking element can penetrate into the recess 108 when the mouth of the shears head 24 is closed, i.e. when the cutting edge 32 is concealed by the corresponding surface of the second cutting blade 40 and the cutting edge 42 is concealed by the corresponding surface of the first cutting blade 30. This then results in a basic position of the two handle-part/shears-head-limb combinations 12 and 14, in which it is not possible for any cutting operation to be executed. This basic position is secured by the slide 110 with the latching element 104, which form a locking device.

A compression spring 112 is provided and is supported both on the first handle part 16 and on the second handle part 20. In the non-loaded state, this compression spring 112 presses the two handle parts 16 and 20 apart from one another and thus opens the shears head 24. The two handle parts 16 and 20 can be moved toward one another counter to the force of this compression spring 112 in order, once again, to move the cutting blades 30 and 40 toward one another.

The run-through shears 10 according to the invention function as follows:

Once the security device has been neutralized by corresponding displacement of the slide 110, the workpiece 26 can be cut. The run-through shears 10 then are manually actuated, a user gripping the handle regions 54 and 72. The hollow between the thumb and forefinger rests in the handle region 54, as does the region of the hand surface, which is offset parallel to the thumb. The rest of the fingers rest in the handle region 72.

For cutting the workpiece 26, the first handle part 16 is then pivoted, about the rotary bearing 66, in the direction of the second handle part 20. The cutting edge 32 of the first cutting blade 30 is thus pivoted toward the cutting edge 42 of the second cutting blade 40, and the two cutting blades 30 and 40 can slide on one another during the cutting operation.

By virtue of being formed as run-through shears 10, the hand is located above the workpiece 26, so that it does not come into contact with cut material 48 and 50; the hand is located at a safe distance from the cut material 48, 50.

Via the guiding surfaces 64 and 78, furthermore, the cut material 48, 50 is guided past the rotary bearing 66, so that there is no need for the cut material to be bent over.

By virtue of the formation of the run-through shears 10 according to the invention, the mechanical function for the pivoting movement of the two handle-part/shears-head-limb combinations 12 and 14 is separate from the cutting function. The cutting function is achieved by the cutting blades 30 and 40. These can be formed as thin metal plates without forming the joint or part of the joint (the sliding surfaces of the rotary bearing 66). These sliding surfaces 92, 96 are formed exclusively on the handle-part/shears-head-limb combinations 12 and 14, to be precise in the transition regions 70 and 52 thereof.

The cutting blades 30, 40 may thus be produced separately from the handle-part/shears-head-limb combinations 12 and 14. In particular, it is thus possible for the handle-part/shears-head-limb combinations 12, 14 to be produced from a plastics material, so that it is possible to achieve a low weight for the run-through shears 10 according to the invention. By virtue of the mounting of the two handle-part/shears-head-limb combinations 12 and 14 and the cutting action (via the cutting blades 30, 40) being separated according to the invention, it is also possible for the run-through shears 10 to be formed with small dimensions.

1. Run-through shears in the case of which the user's hand is located at a distance from the workpiece during cutting, comprising:
a shears head which is formed by a first shears-head limb with a first cutting blade and by a second shears-head limb with a second cutting blade;
a first handle part and a second handle part;
wherein a first handle-part/shears-head-limb combination and a second handle-part/shears-head-limb combination are formed; and
wherein at least one handle part is disposed in an angled manner relative to the shears head; and
a rotary bearing for pivoting the handle-part/shears-head-limb combinations relative to one another;
wherein the cutting blades are individual parts which are fixed on cutting-blade retaining regions of the associated shears-head limbs, and the parts forming the cutting blades are spaced away from the rotary bearing.

2. Run-through shears according to claim 1, wherein the sliding surfaces of the rotary bearing are located outside the parts forming the cutting blades.

3. Run-through shears according to claim 1, wherein a sliding surface of the rotary bearing, said sliding surface being formed on the associated handle-part/shears-head-limb combination, is formed outside the associated cutting-blade retaining region.

4. Run-through shears according to claim 1, wherein the cutting blades are made of metal.

5. Run-through shears according to claim 1, wherein the handle parts are produced from a plastics material.

6. Run-through shears according to claim 1, wherein the shears-head limbs are produced from a plastics material.

7. Run-through shears according to claim 1, wherein the first handle-part/shears-head-limb combination is formed in one piece.

8. Run-through shears according to claim 1, wherein the second handle-part/shears-head-limb combination is formed in one piece.

9. Run-through shears according to claim 1, wherein the shears head has one or more guiding surfaces for spaced-apart guidance of cut material past the rotary bearing.

10. Run-through shears according to claim 9, wherein the first shears-head limb has a guiding surface for cut material.

11. Run-through shears according to claim 9, wherein the second shears-head limb has a guiding surface for cut material.

12. Run-through shears according to claim 9, wherein the guiding surface or guiding surfaces is or are spaced away from the rotary bearing in a height direction.

13. Run-through shears according to claim 9, wherein a guiding surface extends in the direction along a cutting edge of the associated cutting blade and in a direction which is at least approximately parallel to the axis of rotation of the rotary bearing.

14. Run-through shears according to claim 9, wherein a guiding surface extends laterally outward on a shears-head limb, in the direction away from the associated cutting blade.

15. Run-through shears according to claim 9, wherein a cutting blade projects beyond the associated guiding surface.

16. Run-through shears according to claim 1, wherein the rotary bearing is disposed in an extension of the first cutting blade in a direction away from a distal end.

17. Run-through shears according to claim 1, wherein the first handle-part/shears-head-limb combination has a recess in which the second handle-part/shears-head-limb combination is disposed in a rotatable manner.

18. Run-through shears according to claim 17, wherein the recess is bounded toward one side by the cutting-blade retaining region of the first shears-head limb.

19. Run-through shears according to claim 18, wherein the recess is bounded toward the other side by the first handle part.

20. Run-through shears according to claim 17, wherein the recess provides a blocking surface which limits the extent to which the shears head opens.

21. Run-through shears according to claim 17, wherein a depth direction of the recess is parallel to the axis of rotation.

22. Run-through shears according to claim 1, wherein a bearing recess with a sliding surface is formed on one handle-part/shears-head-limb combination, and a shaft stub with an associated sliding surface is seated in a rotationally fixed manner on the other handle-part/shears-head-limb combination.

23. Run-through shears according to claim 1, wherein the cutting blades are fixed on the associated shears-head limb via one or more fastening elements.

24. Run-through shears according to claim 23, wherein the fastening elements are positively locking elements.

25. Run-through shears according to claim 23, wherein cutting blades are fixed in from their surface.

26. Run-through shears according to claim 1, wherein, in the case of the second handle-part/shears-head-limb combination, the second handle part, or an element connected to the second handle part, is connected substantially at right angles to the second shears-head limb.

27. Run-through shears according to claim 1, wherein a compression spring is disposed between the two handle-part/shears-head-limb combinations, said spring opening in the non-loaded state the shears head.

28. Run-through shears according to claim 1, wherein a locking device, by means of which a closed position of the shears head can be fixed, is provided.
